(19) United States
(12) Patent Application Publication
(10) Pub. No.: US 2023/0103985 A1
(43) Pub. Date: Apr. 6, 2023

(54) FACE SPLINE COUPLING FOR DRIVE-WHEEL ARRANGEMENT

(71) Applicant: NTN BEARING CORPORATION OF AMERICA, MT. PROSPECT, IL (US)

(72) Inventors: RONDELL ERVIN BURT, II, FARMINGTON HILLS, MI (US); JON ROBERT BARRETT, HOWELL, MI (US); KRYSTIL ELIZABETH EDWARDS, LIVONIA, MI (US); THOMAS KOZINA, WEST BLOOMFIELD, MI (US)

(73) Assignee: NTN BEARING CORPORATION OF AMERICA, MT. PROSPECT, IL (US)

(21) Appl. No.: 17/491,662

(22) Filed: Oct. 1, 2021

(51) Int. Cl. B60B 27/00; F16D 1/076

(52) U.S. Cl. CPC B60B 27/0031; F16D 1/076; B60B 2320/10; B60B 2900/131; B60B 2900/133; B60B 2900/113; B60B 2900/111; F16D 2300/22

(57) ABSTRACT

A face spline coupling for transmitting torque between a wheel end unit and a driven shaft arranged in a longitudinal axis of a drive-wheel arrangement for a motor vehicle includes a first face spline formed in the wheel end unit and a second face spline formed in the driven shaft. The first face spline is generally perpendicular to the longitudinal axis and faces the driven shaft, and the second face spline is also generally perpendicular to the longitudinal axis and faces the wheel end unit. The first and second face splines are meshed together and detachably coupled by inter-fitting teeth of each of the first and second face splines. In addition, the teeth in each of the first and second face splines are formed in a helical configuration.

### TECHNICAL FIELD

This present disclosure relates to a face spline coupling between a wheel end unit and a driven shaft in a motor vehicle. In particular, the present disclosure relates to the inter-fitting teeth in the face spline coupling for transmitting torque in the drive-wheel arrangement.

### BACKGROUND

The statements in this section merely provide background information related to the present disclosure and may not constitute prior art.

Conventional motor vehicles with internal combustion engines as a prime mover provide power to road engaging wheels through axles or other rotary couplings. Power can be provided to front or rear wheels or all wheels in four-wheel-drive and so-called all-wheel-drive applications. For road engaging wheels that have an independent suspension or are required to have steering motion, flexibility in the drive coupling is needed. This is often provided through the use of a shaft coupled to the driven wheel through a so-called universal joint or the more sophisticated type of universal joint called a constant velocity joint (CVJ).

Often half shafts are provided between a front engine transaxle and front driven wheels, or through a rear mounted differential where independent suspension movement of the rear wheels occurs. For these and related systems, a coupling between the wheel end unit and the drive-shaft of half-shaft is needed. For manufacturing reasons, the drive-shaft or half-shaft and the wheel end units are separate and need to be assembled during vehicle production. In order to transmit torque between the driven shaft and the wheel hub, couplings such as splined shafts are used. In a conventional splined shaft connection, the external surface of a shaft end features splines which are arranged around the outer surface of the shaft and aligned with the longitudinal axis of the shaft. The splined stub end is received by a female splined center section of the wheel hub. Conventional longitudinal splined connections have been used for a very long time and generally perform well.

More recently a different spline arrangement is being used for providing a detachable coupling between wheel end units and driven shafts, referred to as a face spline coupling. In such a coupling, two mating face surfaces, generally perpendicular to the longitudinal axis of the hub and shaft are meshed together and the inter-fitting teeth of the spline provide the detachable drive coupling. The system provides manufacturability advantage over conventional spline connections. In presently used face spline arrangements the meshing teeth of the face spline are oriented along radials from the longitudinal axis. Various forms of teeth profiles are known for such systems.

### SUMMARY

The present disclosure relates to inter-fitting teeth in a face spline coupling for transmitting torque in a drive-wheel arrangement for a motor vehicle. In accordance with an aspect of the present disclosure, the face spline coupling for transmitting torque between a wheel end unit and a driven shaft arranged in a longitudinal axis of the drive-wheel arrangement includes a first face spline formed in the wheel end unit and a second face spline formed in the driven shaft. The first face spline is generally perpendicular to the longitudinal axis and faces the driven shaft, and the second face spline is generally perpendicular to the longitudinal axis and faces the wheel end unit. The first and second face splines are meshed together and detachably coupled by inter-fitting teeth of the first and second face splines. In addition, the teeth in each of the first and second face splines are formed in a helical configuration.

In accordance with a further aspect of the present disclosure, the teeth formed in each of the first and second face splines include flanks formed along lines displaced from the longitudinal axis of the wheel end unit and the driven shaft. The lines are tangent to a circle centered at the longitudinal axis of the wheel end unit and the driven shaft such that the lines are tilted with a helix angle relative to a center line passing through a point on the longitudinal axis in the face spline surface.

In accordance with a further aspect of the present disclosure, the face spline coupling having the inter-fitting teeth formed in the helical configuration is configured to reduce back lash, vibration, and noise generated in the face spline coupling.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a cross-section view of a wheel end unit coupled with a constant velocity joint (CVJ) in accordance with a form of the present disclosure;

FIG. 2A is a perspective view of the wheel end unit of FIG. 1, and FIG. 2B is a side view showing a face spline formed in the wheel end unit of FIG. 1;

FIG. 3A is a perspective view of the CVJ of FIG. 1, and FIG. 3B is a side view showing a face spline formed on the CVJ of FIG. 1; and

FIG. 4 shows a detailed view of teeth of the face spline formed in each of the wheel end unit and the CVJ of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

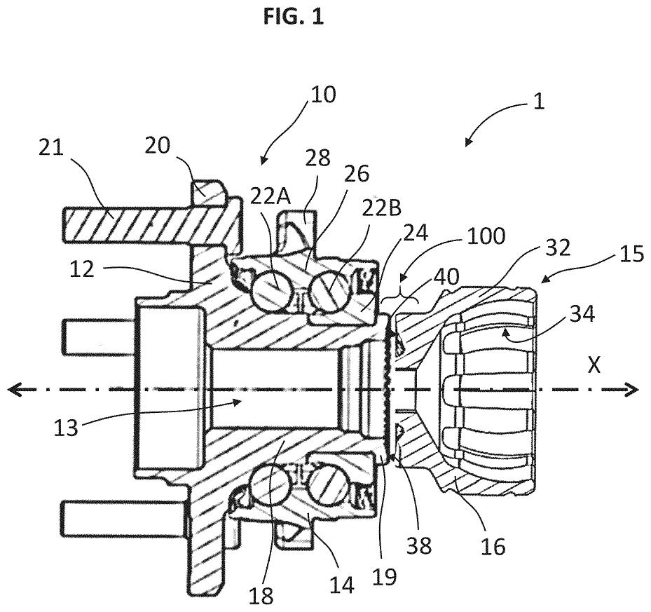

Referring now to FIG. 1, a drive-wheel arrangement 1 in a vehicle (not shown) includes a wheel end unit 10 having a wheel hub 12 and a wheel bearing 14, and a driven shaft 15 including a constant velocity joint (CVJ) 16. Generally, the wheel end unit 10 is coupled with the driven shaft 15 for transmitting torque from the power unit in the vehicle. As shown in FIG. 1, the wheel end unit 10 and the CVJ 16 are arranged in a longitudinal axis X as an aligned position. The wheel hub 12 includes a sleeve portion 18 for accommodating the wheel bearing 14 and a wheel flange 20 for fastening a vehicle wheel (not shown) by threaded bolts 21. In FIG. 1, furthermore, the wheel hub 12 is mounted via bearing balls 22A and 22B such that the wheel hub 12 can rotate about the longitudinal axis X with respect to a bearing flange 20, which is fixed to the vehicle (not shown). The wheel hub 12 further includes a collar 19 radially protruding from the sleeve portion 18, which opposite side from the wheel flange 20 in the longitudinal axis X of the wheel end unit 10.

In FIG. 1, the wheel bearing 14 includes two rows of the bearing balls 22A and 22B, and an inner and outer bearing race 24 and 26. As shown in FIG. 1, in the wheel bearing 14, the bearing balls 22A close to the wheel flange 20 of the wheel hub 12 are displaced and run between the outer surface of the sleeve portion 18 and the inner surface of the outer bearing race 26, and the other bearing balls 22B close to the collar 19 of the wheel hub 12 are displaced and run between the outer surface of the inner bearing race 24 and the inner surface of the outer bearing race 26. Accordingly, the wheel hub 12 coupled with the CVJ 16 rotates about the longitudinal axis X relative to the wheel bearing 14, which fixed to the vehicle.

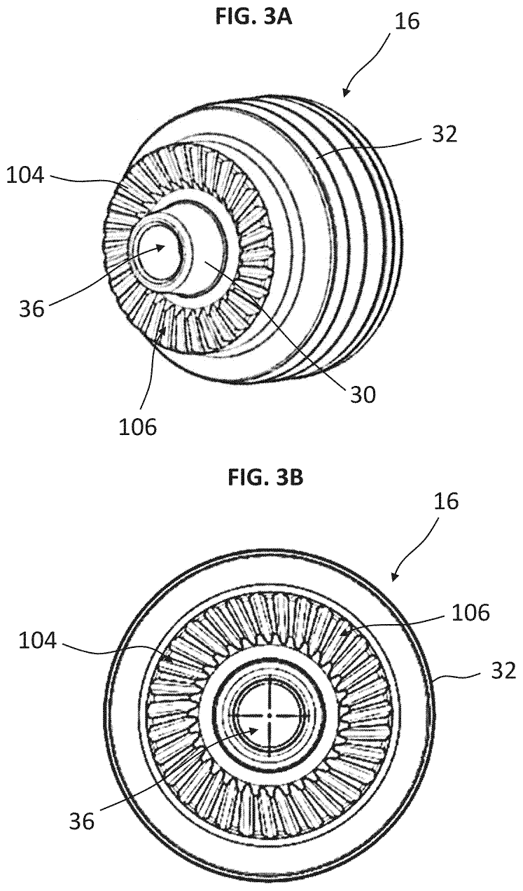

As described above, generally, the driven shaft 15 connected with a power unit in the vehicle transmits torque to the wheel end unit 10 for rotating the wheel hub 12. In FIG. 1, the driven shaft 15 includes the constant velocity joint (CVJ) 16 which cannot move axially but is detachably coupled to the wheel hub 12. Generally, the CVJ 16 includes an input shaft (not shown) receiving its movement from the power unit of the vehicle and an output shaft 30 extending from an outer race 32 of the CVJ 16 (see FIG. 3A). The CVJ 16 further includes outer tracks 34 formed in an inner surface of the outer race 32, inner tracks (not shown) formed in an inner joint part (not shown), and torque transmitting elements (not shown) arranged between the inner track and the outer track 34 inside the outer race 32. As shown in FIGS. 1 and 3A, the output shaft 30 of the CVJ 16 is formed as a stub shaft having a hole 36, which is formed by a threading tap such that the stub shaft receives a connecting member (not shown) when the wheel end unit 10 and the CVJ 16 are engaged. In FIG. 1, the wheel hub 12 includes a central bore 13 inside the sleeve portion 18. The connecting member (not shown) provided in the form of a bolt (not shown) through the central bore 13 of the wheel hub 12 is fastened into the hole 36 of the stub shaft formed in the CVJ 16 such that the wheel end unit 10 and the driven shaft 15 having the CVJ 16 are clamped in the drive-wheel arrangement 1 so that the wheel end unit 10 and the driven shaft 15 do not separate while torque is transmitted.

In FIG. 1, for the purpose of transmitting torque between the wheel end unit 10 and the CVJ 16 in accordance with an embodiment of the present disclosure, a first face spline 102 formed in the collar 19 of the wheel hub 12 engages a corresponding second face spline 104 formed in the outer race 32 of the CVJ 16. The first face spline 102 is formed in an end surface 38 of the collar 19 which radially extends from the sleeve portion 18 and faces the CVJ 16 in the axial direction of the longitudinal axis X. In addition, the first face spline 102 is paired with the corresponding second face spline 104 formed on a flat surface 40 which is around the output shaft 30 and faces the wheel end unit 10 in the axial direction of the longitudinal axis X. As shown in FIG. 1, accordingly, the first and second face splines 102 and 104 face each outer and are detachably coupled between the wheel end unit 10 and the driven shaft 15 when the wheel end unit 10 and the CVJ 16 are clamped by the connecting member (not shown) in the drive-wheel arrangement 1. In such a face spline coupling 100, the end surface 38 having the first face spline 102 and the flat surface 40 having the second face spline 104 are generally perpendicular to the longitudinal axis X of the wheel end unit 10 and the CVJ 16.

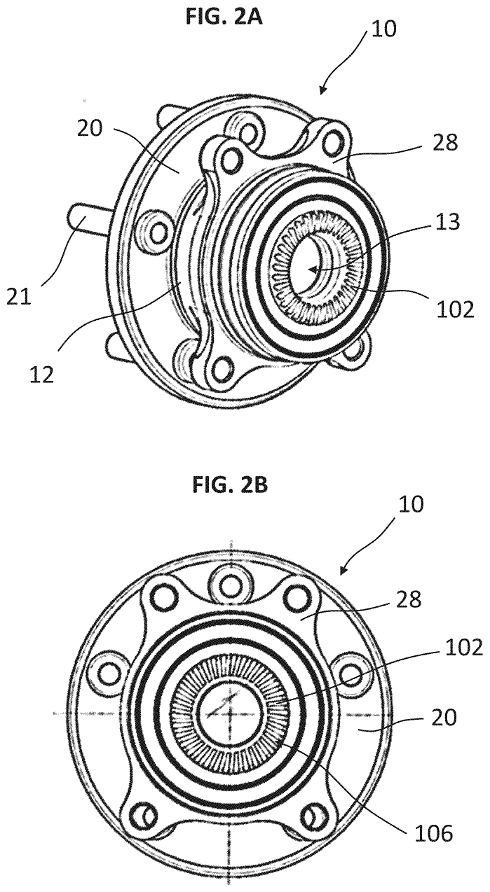

FIGS. 2A and 3A each show the first and second face splines 102 and 104 formed in each of the wheel hub 12 and the CVJ 16. In FIGS. 2A and 3A, the first and second face splines 102 and 104 are meshed together such that both the first and second face splines 102 and 104 have the same teeth, which are inter-fitting one another. As shown in FIG. 1, accordingly, the inter-fitting teeth 106 in the face spline coupling 100 are detachably coupled such that the first and second face splines 102 and 104 are clamped axially inside one another and against one another by means of the connecting member (not shown), which fastens both the wheel end unit 10 and the driven shaft 15.

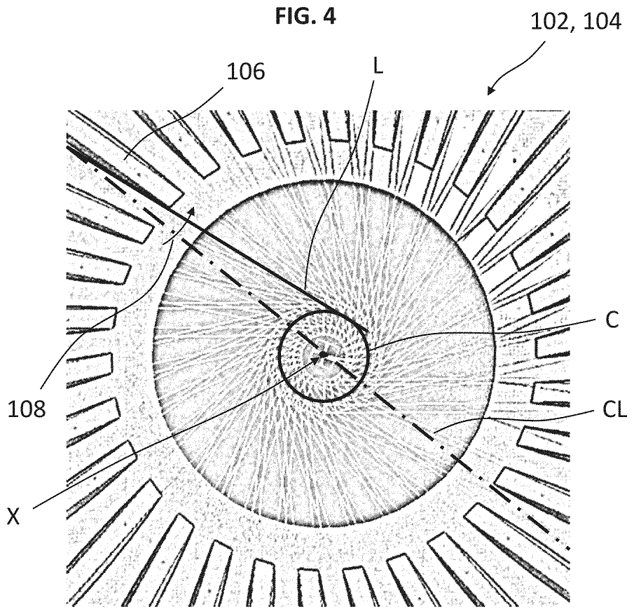

FIGS. 2B and 3B each show a side view of each of the wheel end unit 10 and the CVJ 16, and FIG. 4 shows a detailed view of one of the first and second face splines 102 and 104. In FIGS. 2B, 3B, and 4, the individual tooth 106 in each of the first and second face spline 102 and 104 is formed with a helical configuration, which is tilted with a helix angle 108. Accordingly, flanks of the individual tooth 106 are formed along lines L displaced from the longitudinal axis X of the wheel hub 12 and the CVJ 16, and these flank lines L are tangent to a circle C centered at the longitudinal axis X such that when the splines are projected inward to the center of each of the face spline surface, the splines do not meet at the center point on the longitudinal axis X of the wheel hub 12 and the CVJ 16. The displaced lines L are tilted with the helix angle 108 relative to a center line CL passing through the center point on the longitudinal axis in the face spline surface. Generally, the helix angle 108 of the splines is 2.5° to 17.5°, preferably 5° to 15°, and most preferably 7.5° to 12.5°. The dimension (such as a radius) of the circle C centered at the longitudinal axis X is defined according to the titled helix angle 108. In FIG. 4, the teeth 106 formed in the first and second face splines 102 and 104 according to an embodiment of the present disclosure, have the helical configuration and are meshed together with the parts having mirror image symmetry.

As shown in FIGS. 2B and 3B, the first and second face splines 102 and 104 formed with the teeth 106 having the helical form are manufactured using different and various methods such as a coining, cutting, machining, or forging. As shown in FIG. 4, in addition, the upper face of each tooth 106 formed in the first and second face splines 102 and 104 is formed as a sloping-down surface inward along the flank lines L, which is toward the longitudinal axis X. In FIG. 1, the face spline coupling 100 having the teeth 106 formed with the helical configuration between the wheel end unit 10 and the driven shaft 15 according to the present disclosure is configured for reducing back lash, vibration and noise generated in the face coupling in the drive-wheel arrangement 1. In addition, the first and second face splines 102 and 104 formed in each of the wheel hub 12 and the CVJ 16 generally reduces weight and also are easy to assemble in the drive-wheel arrangement 1.

While the above description constitutes the preferred embodiments of the present invention, it will be appreciated that the invention is susceptible to modification, variation and change without departing from the proper scope and fair meaning of the accompanying claims.

What is claimed is:

1. A face spline coupling for transmitting torque between a wheel end unit and a driven shaft arranged in a longitudinal axis of a drive-wheel arrangement for a motor vehicle, the face spline coupling comprising:
a first face spline formed in the wheel end unit, the first face spline being generally perpendicular to the longitudinal axis and facing the driven shaft; and
a second face spline formed in the driven shaft, the second face spline being generally perpendicular to the longitudinal axis and facing the wheel end unit,
wherein the first face spline and the second face spline are meshed together and detachably coupled by inter-fitting teeth of each of the first face spline and the second face spline, and wherein the teeth in each of the first face spline and the second face spline are formed in a helical configuration.

2. The face spline coupling of claim 1, wherein the teeth formed in each of the first face spline and the second face spline include flanks formed along lines displaced from the longitudinal axis of the wheel end unit and the driven shaft.

3. The face spline coupling of claim 2, wherein the lines are tangent to a circle centered at the longitudinal axis of the wheel end unit and the driven shaft such that the lines are tilted with a helix angle relative to a center line passing through a point on the longitudinal axis in the face spline surface.

4. The face spline coupling of claim 3, wherein in the helical configuration of the teeth, the displaced lines are tilted with the helix angle having 5° to 15°.

5. The face spline coupling of claim 1, wherein the face spline coupling having the inter-fitting teeth formed in the helical configuration is configured to reduce back lash, vibration, and noise generated in the face spline coupling.

6. The face spline coupling of claim 1, wherein the driven shaft includes a constant velocity joint (CVJ) having an outer race such that the second face spline is formed on a flat surface on the outer race, which faces the wheel end unit in the longitudinal axis.

7. The face spline coupling of claim 1, wherein the wheel end unit includes a wheel hub having a collar such that the first face spline is formed on an end surface on the collar, which faces the CVJ in the longitudinal axis.
